(19) United States
(12) Patent Application Publication
(10) Pub. No.: US 2005/0087333 A1
(43) Pub. Date: Apr. 28, 2005

(54) System for heating and cooling the interior of a motor vehicle

(75) Inventors: Oliver Horn, Muenchen (DE); Noureddine Khelifa, Muenchen (DE); Wolfgang Kramer, Muenchen (DE)

Correspondence Address: NIXON PEABODY, LLP, 401 9TH STREET, NW, SUITE 900, WASHINGTON, DC, 20004-2128, US

(73) Assignee: Webasto AG, Stockdorf (DE)

(21) Appl. No.: 10/944,401

(22) Filed: Sep. 20, 2004

(30) Foreign Application Priority Data
Sep. 18, 2003 (DE) 103 43 225.6

(51) Int. Cl. B60H 1/00; B60H 1/32; F25D 17/02

(52) U.S. Cl. 165/203; 62/434; 62/244

(57) ABSTRACT

A system for heating and cooling the interior of a motor vehicle, having a refrigerating circuit with a first climate control device (10) which is designed to heat or cool the front area of the interior, and with a second climate control device (12) which is designed to heat or cool the rear area of the interior. The first climate control device (10) has a first evaporator (14) and the second climate control device (12) has a second evaporator (16). The second climate control device (12) also has a first heat exchanger (18) which is connected via a heat transfer medium circuit (30) to a latent cold storage device (20) which can be charged with cold by a third evaporator (22) which can be connected to the refrigerating circuit.

### BACKGROUND OF THE INVENTION

1. Field of Invention

The invention relates to a system for heating and cooling the interior of a motor vehicle, with a first climate control device which is designed to heat or cool the front area of the interior, and with a second climate control device which is designed to heat or cool the rear area of the interior, there being a first evaporator in the first climate control device which can be connected to the refrigerating circuit and a second evaporator in the second climate control device which can be connected to the refrigerating circuit.

2. Description of Related Art

Climate control devices are also called climate control boxes or HVACs (“Heat Ventilation Air Condition”). In conjunction with passenger cars, generic systems are currently used especially on the U.S. market. However, the generic systems can also be used for climate control of the cabs of trucks, especially in cabs which have a driver area, a passenger area and a sleeper berth area. In this case, the first climate control device can be assigned to the driver and passenger area, while the second climate control device can be assigned to the sleeper berth area.

### SUMMARY OF THE INVENTION

A primary object of the present invention is to develop the generic systems such that both effective climate control of the rear area while driving and also stationary climate control of at least of the rear area are enabled.

This object is achieved in a system for heating and cooling the interior of a motor vehicle, with a first climate control device which is designed to heat or cool the front area of the interior, and with a second climate control device which is designed to heat or cool the rear area of the interior, there being a first evaporator in the first climate control device which can be connected to the refrigerating circuit, and a second evaporator in the second climate control device which can be connected to the refrigerating circuit, by the second climate control device having a first heat exchanger which is connected via a heat transfer medium circuit to a latent cold storage device which can be charged with cold by a third evaporator which can be connected to the refrigerating circuit.

The system in accordance with the invention is based on the generic prior art in that, in the second climate control device, there is a first heat exchanger which is connected via a heat transfer medium circuit to a latent cold storage device which can be charged with cold by a third evaporator which can be connected to the refrigerating circuit. The invention makes it possible, in particular, to effectively cool the rear area of the interior while driving, by transferring the cold which is being released on the second evaporator to a corresponding air flow. Furthermore, the invention makes it possible to cool the rear area of the interior in stationary operation by transferring the cold stored in the latent cold storage device to a corresponding air flow via a first heat exchanger. Moreover, it is possible in so-called pull-down operation to transfer to an air flow both the cold which is being released on the second evaporator and also the cold stored in the latent cold storage device for cooling the rear area of the interior.

Although the invention can be used especially advantageously in conjunction with trucks, it is not limited to this application, but can also be used in conjunction with passenger vehicles. In this case, preferably, additional measures are taken to enable stationary climate control of the front area of the interior. For example, for this purpose, in the first climate control device, there can be another heat exchanger which is likewise incorporated into the heat transfer medium circuit or which interacts with another latent cold storage device.

In preferred embodiments of the system of the invention, it is provided that from the group of the first evaporator, the second evaporator and the third evaporator, there are at least two evaporators in parallel relative to the direction of flow of the refrigerant. In particular, when a separate expansion element is assigned to each evaporator, this arrangement makes it possible to operate at least two parallel evaporators independently, and there can be suitable valve means for this purpose.

In this connection, it is considered especially advantageous if it is provided that the first evaporator, the second evaporator and the third evaporator are located in parallel relative to the direction of refrigerant flow. In this case, preferably, all of the evaporators can be operated independently of one another.

The system of the invention can be advantageously developed such that the first heat exchanger and the second evaporator are located in series relative to the direction of air flow. This arrangement, for example, makes it possible to achieve especially strong cooling of the air flowing through both the first heat exchanger and also the second evaporator, for example, in pull-down operation.

Furthermore, in certain embodiments of the system in accordance with the invention, it can be provided that, to heat the rear area, there is an air heater. The air heater can be operated especially electrically or with fuel. In this connection, it is preferred that the air heater is assigned to the second climate control device. In particular, in the case of an electrical air heater, it is possible to place the entire air heater in the second climate control device as a result of the small space requirement.

The system according to the invention can also be developed advantageously in that it can use the first heat exchanger for heating the rear area. In this case, since the first heat exchanger can be used selectively for heating or for cooling the air flowing through it, on the side of the heat transfer medium circuit, there is preferably a valve arrangement via which the first heat exchanger can be coupled to other system components depending on the respective mode of operation in a manner which is suitable at the time.

Furthermore, embodiments are possible in which it is provided that there is a third heat exchanger in the second climate control device for heating the rear area. This approach is advantageous, for example, when the rear area is also to be heatable with exhaust heat from the engine, i.e., via the refrigerant, but it is undesirable to allow refrigerant to flow through the latent cold storage device, for example, to be able to reliably prevent deposits in the latent cold storage device.

Within the framework of the invention, there are also approaches in which it is provided that there is a heat transfer medium heater to heat the rear area which can be incorporated into the heat transfer medium circuit. The heat transfer medium heater can also be especially an electrically driven or fuel-fired heat transfer medium heater. The use of a heat transfer medium heater is especially easily possible when the first heat exchanger can be used to heat the rear area.

Furthermore, embodiments of the system of the invention are considered advantageous in which it is provided that heat can be removed from the engine cooling circuit for heating the rear area. In this connection, it is especially efficient if the first heat exchanger can be used to heat the rear area, therefore can be coupled to the engine cooling circuit.

One especially preferred development of the system of the invention calls for the heat or cold to be able to be stored selectively in the latent cold storage device and for the heat stored in the latent cold storage device to be able to be used for heating the rear area. However, if the heat stored in the latent cold storage device should not be sufficient for heating the rear area, this heat can also be advantageously used to increase, for example, the flow temperature of the heat transfer medium heater which can thus be operated with less power.

In the above explained connection it is considered especially advantageous if it is provided that the latent cold storage device can be coupled to the engine cooling circuit for storage of heat. In this way, engine exhaust heat which has otherwise been released uselessly into the environment can be used, for example, for stationary heating operation.

In particular, in the above explained connection, it is furthermore preferably provided that the latent cold storage device contains a second heat exchanger via which, selectively, heat can be supplied, heat discharged or cold discharged. The second heat exchanger is preferably connected to a valve arrangement via which the second heat exchanger can be coupled to other system components in the manner which is suitable at the time.

One important basic idea of the invention is that it is advantageous to provide, in the second climate control device which is assigned to the rear area, both the second evaporator and also the first heat exchanger in order to achieve optimum climate control both while driving and also when stationary; this is not easily possible with systems in which the second climate control device does not have its own evaporator.

The invention is explained detail below using preferred embodiments by way of example and with reference to the accompanying drawings.

### BRIEF DESCRIPTION OF THE DRAWINGS

FIG. 1 is a schematic depiction of a first embodiment of the system in accordance with the invention,

FIG. 2 is a schematic depiction of a second embodiment of the system of the invention,

FIG. 3 is a schematic depiction of a third embodiment of the system according to the invention,

FIG. 4 is a schematic depiction of a fourth embodiment of the system in accordance with the invention, and

FIG. 5 is a schematic depiction of a fifth embodiment of the system of the invention.

### DETAILED DESCRIPTION OF THE INVENTION

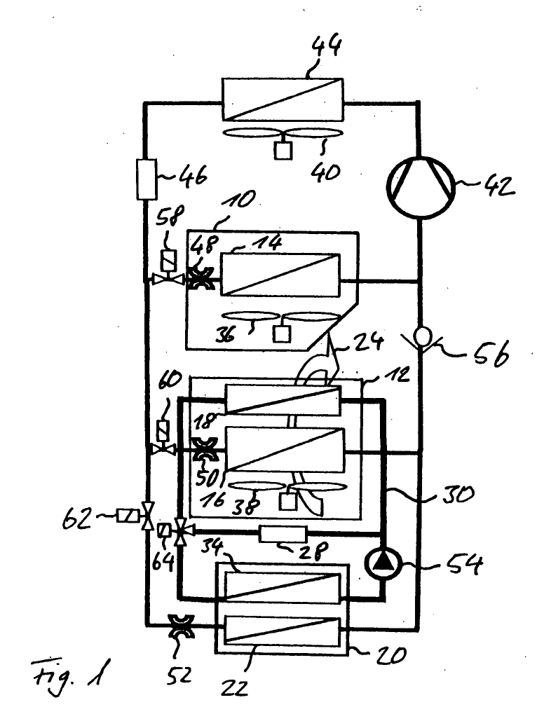

FIG. 1 shows a first embodiment of the system as of the invention. A compressor 42, a condenser 44 with an assigned condenser fan 40, a collector/drier 46, a first valve 58, a first expansion element 48 and a first evaporator 14 with a first fan 36 assigned to the latter form a compression refrigerating circuit in the conventional manner. The first evaporator 14 is arranged together with the first fan 36 in a first climate control device 10 in which conventionally other components which are not shown, such as, for example, a heating heat exchanger, are provided. The first climate control device 10 is located in the front area of a vehicle interior, and an air flow which has been produced by the first fan 36 can be cooled via the first evaporator 14. The compression refrigerating circuit shown in FIG. 1 furthermore comprises a second evaporator 16, for which a second expansion element 50, a second valve 60 and a second housing 38 are assigned to this second evaporator 16. The second evaporator 16 is located parallel to the first evaporator 14 relative to the refrigerant flow, there being a return valve 56 between the outlet of the first evaporator 14 and the outlet of the second evaporator 16. The second evaporator 16 is housed in a second climate control device 12 which is assigned to a rear area of the interior of the motor vehicle so that, when the compressor 42 is running, an air flow which is produced by the second fan 38 in the direction 24 of air flow can be cooled via the second evaporator 16. Furthermore, the compression refrigerating circuit which is shown in FIG. 1 comprises a third evaporator 22 to which a third expansion element 52 and a third valve 62 are assigned. The third evaporator 22 is likewise arranged parallel to the first evaporator 14 and thus also parallel to the second evaporator 16 relative to the refrigerant flow. The third evaporator 22 is housed in the latent cold storage device 20 in which the cold which is being released on the third evaporator can be stored. Using the first valve 58, the second valve 60 and the third valve 62, it is possible to operate only the evaporator or the evaporators which are needed at the time.

In addition to the above described refrigerating circuit, the system as shown in FIG. 1 has a heat transfer medium circuit 30 in which, for example, a water/glycol mixture may be used as the heat exchange medium. A component of the heat transfer medium circuit 30 which is shown in FIG. 1 is a first heat exchanger 18 which is located in the second climate control device 12 in series with the second evaporator 16 relative to the air flow, a second heat exchanger 34 which is located in the latent cold storage device 20, a heat transfer medium pump 54, a for example electrically operated heat transfer medium heater 28 and a first heat transfer medium valve 64. The first heat transfer medium valve 64 can likewise be formed, like all other valves present in the system, for example, by a solenoid valve.

The system as shown in FIG. 1 makes it possible while driving, i.e., when the compressor 42 is running, to cool the front area of the interior via the first evaporator 14 and to cool the rear area of the interior via the second evaporator 16. At the same time, the latent cold storage device 20 can be charged with cold. This is of course likewise possible when none or only one of the first evaporator 14 and of the second evaporator 16 is active. In stationary operation, i.e., with the compressor 42 turned off, in the first working position of the first heat transfer medium valve 64, a heat transfer medium circuit can be formed proceeding from the active heat transfer medium pump 54, through the first heat exchanger 18, through the first heat transfer medium valve 64 to the second heat exchanger 34 and back to the heat transfer medium pump 54. Thus, especially in stationary operation, the cold stored in the latent cold storage device 20 can be released to the rear area of the interior via the first heat exchanger 18. In the second working position of the first heat transfer medium valve 64, a heat transfer medium heater 28 is incorporated into the heat circuit, the heat transfer medium heater 28 being equipped with its own pump which is not shown. In this case, the heat transfer medium circuit, proceeding from the heat transfer medium heater 28, is formed by the first heat exchanger 18, by the first heat transfer medium valve 64 and back to the heat transfer medium heater 28, so that heat can be supplied to the rear area of the interior via the first heat exchanger 18.

The system shown in FIG. 1 makes it possible to cool the rear area while driving via the second evaporator. During heating operation, efficient heating by formation of an isolated circuit becomes possible. Furthermore, the integration of the latent cold storage device into the refrigerating circuit requires only a few modifications to known systems since, in principle, as far as the evaporator of the rear system, no modifications are necessary.

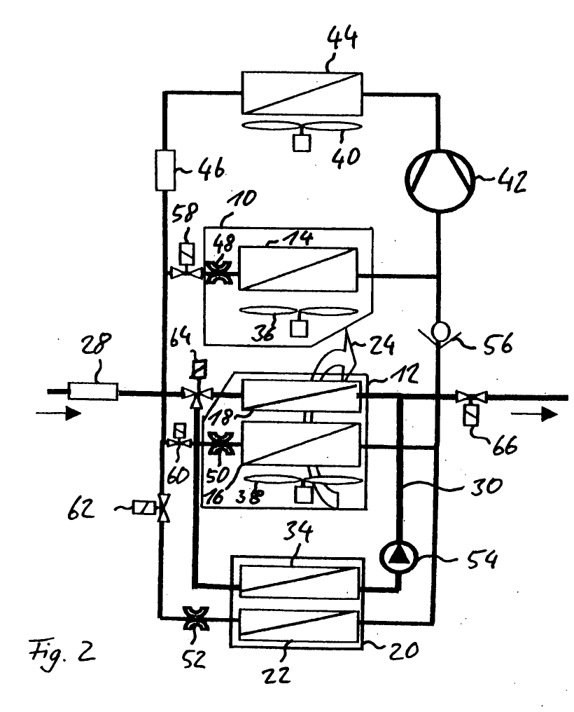

FIG. 2 shows a second embodiment of the system in accordance with the invention. The refrigerating circuit of the system shown in FIG. 2 corresponds to the refrigerating circuit of the system from FIG. 1 and is therefore not explained again.

The heat transfer medium circuit 30 of the system as shown in FIG. 2 differs from the heat transfer medium circuit of the system as shown in FIG. 1 in that, to heat the rear area, an isolated circuit is not formed, but recourse is had to an external heating circuit which, in the illustrated case, comprises a heat transfer medium heater 28 and a second heat transfer medium valve 66. In heating operation, the first heat transfer medium valve 64 is moved into a working position, in which the heat transfer medium emerging from the heat transfer medium heater can flow through the first heat transfer medium valve 64, through the first heat exchanger 18 and through the opened second heat transfer medium valve 66.

The latent cold storage device 20 is charged and discharged with cold as in the system as shown in FIG. 1 and is therefore not explained again.

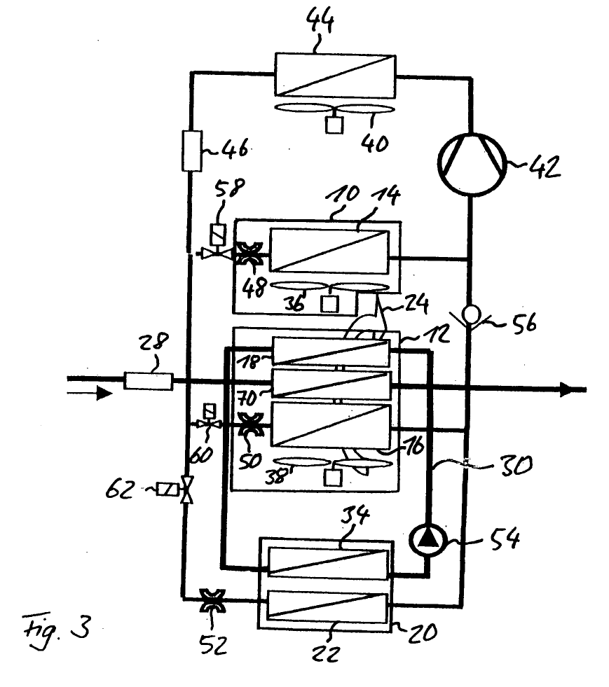

FIG. 3 shows a third embodiment of the system in accordance with the invention. The refrigerating circuit of the system as shown in FIG. 3 corresponds to the refrigerating circuit of the system from FIG. 1 and is therefore not explained again.

The heat transfer medium circuit 30 of the system from FIG. 3 differs from the heat transfer medium circuit of the system from FIG. 2 in that, for heating operation, there is a separate third heat exchanger 70 in the second climate control device 12, this third heat exchanger 70 being supplied by a heat transfer medium heater 28. In this approach, additional valves in the heat transfer medium circuit can be omitted.

The latent cold storage device 20 is charged and discharged with cold in the system shown in FIG. 3 as in the system from FIG. 1 and is therefore not explained again.

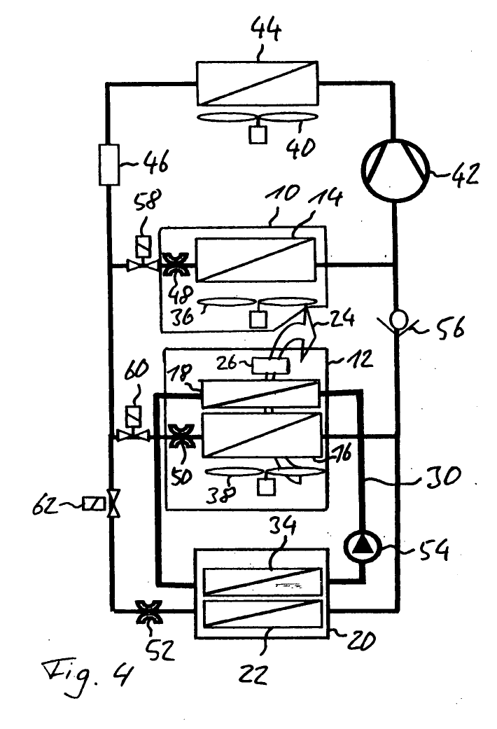

FIG. 4 shows a fourth embodiment of the system according to the invention. The refrigerating circuit of the system shown in FIG. 4 corresponds to the refrigerating circuit of the system from FIG. 1 and is therefore not explained again.

The heat transfer medium circuit 30 of the system as shown in FIG. 4 differs from the above explained embodiments in that it is not designed for heating. In order to be able to heat the rear area of the interior with the system as shown in FIG. 4 nevertheless, relative to the direction 24 of air flow, downstream of the first heat exchanger 18, there is an air heater 26 with which the air flow produced by the second fan 38 can be heated if necessary. Since the heat transfer medium circuit 30 in this embodiment is designed only for discharging the latent cold storage device 20, in this case, the heat transfer medium valves can be omitted.

The latent cold storage device 20 is charged and discharged with cold in the system shown in FIG. 4 as in the system from FIG. 1 and is therefore not explained again.

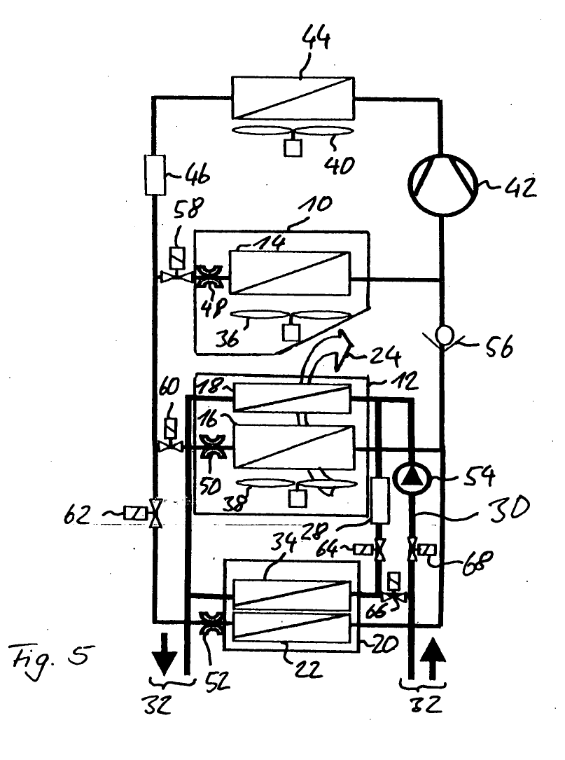

FIG. 5 shows a fifth embodiment of the system of the invention. The refrigerating circuit of the system shown in FIG. 5 corresponds to the refrigerating circuit of the system from FIG. 1 and is therefore not explained again.

The heat transfer medium circuit 30 of the system from FIG. 5, however, in comparison to the above explained embodiments has expanded functionality since the latent cold storage device in this embodiment can be selectively used for storage of heat or cold.

In the system as shown in FIG. 5, the heat transfer medium circuit comprises a heat transfer medium pump 54, the first heat exchanger 18, the second heat exchanger 34, a heat transfer medium heater 28 and a first heat transfer medium valve 64, a second heat transfer medium valve 66 and a third heat transfer medium valve 68, and the heat transfer medium circuit 30 via the second heat transfer medium valve 66 and the third heat transfer medium valve 66 can be connected to an engine cooling circuit 32 which is shown only schematically. When the second heat transfer medium valve 66 is opened, hot refrigerant flows out of the engine cooling circuit 32 through the second heat exchanger 34 so that heat can be stored in the latent cold storage device 20. At the same time, when the third heat transfer medium valve 68 is opened and the heat transfer medium pump 54 is active, hot refrigerant also flows through the first heat exchanger 18 so that the rear area of the interior can be heated. Of course, it is likewise possible, with the third heat transfer medium valve 68 opened, to close the first heat transfer medium valve 64 and the second heat transfer medium valve 66 so that hot refrigerant flows only through the first heat exchanger 18.

In order to use the heat stored in the latent cold storage device 20 for heating the rear area of the interior, there are fundamentally two possibilities. If the heat stored in the latent cold storage device 20 is adequate for heating the rear area, the first heat transfer medium valve 64 is closed and the second heat transfer medium valve 66 is opened in the same manner as the third heat transfer medium valve 68. When the heat transfer medium pump 54 is active, thus heat transfer medium circulation takes place between the first heat exchanger 18 and the second heat exchanger 34 so that the heat stored in the latent cold storage device 20 can be released via the first heat exchanger 18. When the heat stored in the latent cold storage device 20 is not enough to heat the rear area, the stored heat can still be used advantageously to increase the flow temperature of a heat transfer medium heater 28 which has its own heat transfer medium pump which is not shown. In this case, the first heat transfer medium valve 64 is opened and the second heat transfer medium valve 66 is closed like the third heat transfer medium valve 66. When the pump of the heat transfer medium heater 28 is active, thus the heat transfer medium which has been preheated by the latent cold storage device 20 is supplied to the heat transfer medium heater 28 and is further heated there, before the heat transfer medium passes through the heat exchanger 18 and releases heat there.

The latent cold storage device 20 is charged and discharged with cold in the system shown in FIG. 5 (with the first heat transfer medium valve 64 closed) as in the system from FIG. 1 and is therefore not explained again.

The features of the invention which are disclosed in the description above, in the drawings and in the claims can be important both individually and also in any combination for implementation of the invention.

1. System for heating and cooling the interior of a motor vehicle, having a refrigerating circuit with a first climate control device for selectively heating and cooling a front area of the interior, and with a second climate control device for selectively heating and cooling a rear area of the interior, wherein the first climate control device comprises a first evaporator and wherein the second climate control device comprises a second evaporator, and a first heat exchanger which is connected via a heat transfer medium circuit to a latent cold storage device which is adapted to be charged with cold and comprises a third evaporator which is connectable to the refrigerating circuit.

2. System as claimed in claim 1, wherein from the group formed of the first evaporator, the second evaporator and the third evaporator, at least two of said evaporators are arranged in parallel relative to a direction of flow of refrigerant in the system.

3. System as claimed in claim 1, wherein the first evaporator, the second evaporator and the third evaporator are arranged in parallel relative to a direction of refrigerant flow in the system.

4. System as claimed in claim 1, wherein the first heat exchanger and the second evaporator are located in series relative to a direction of air flow through the system.

5. System as claimed in claim 1, wherein an air heater is provided for heating of the rear area.

6. System as claimed in claim 5, wherein the air heater is assigned to the second climate control device.

7. System as claimed in claim 1, wherein the first heat exchanger is adapted for heating the rear area.

8. System as claimed in claim 1, wherein in the second climate control deice comprises a third heat exchanger for heating the rear area.

9. System as claimed in claim 1, wherein the heat transfer medium circuit comprises a heat transfer medium heater for heating the rear area.

10. System as claimed in claim 1, further comprising means for removing heat from a vehicle engine cooling circuit for heating the rear area.

11. System as claimed in claim 1, wherein the latent cold and heat storage device is adapted for selectively storing heat or cold and wherein heat stored in the latent cold and heat storage device is usable for heating the rear area.

12. System as claimed in claim 11, wherein the latent cold and heat storage device is adapted for being coupled to an engine cooling circuit for storage of heat.

13. System as claimed in claim 12, wherein the latent cold and heat storage device contains a second heat exchanger which is adapted for selectively supplying heat, discharging heat and discharging cold.

14. System as claimed in claim 11, wherein the latent cold and heat storage device contains a second heat exchanger which is adapted for selectively supplying heat, discharging heat and discharging cold.
